(19) United States
(12) Patent Application Publication
(10) Pub. No.: US 2016/0318684 A1
(43) Pub. Date: Nov. 3, 2016

(54) POUCH CONTAINER

(71) Applicant: MONDI KSP CO., LTD., Anyang-si, Gyeonggi-do (KR)

(72) Inventors: Byung-chul Jo, Seoul (KR); Byoung-gu Cho, Seoul (KR); Byung-kwon Cho, Seoul (KR)

(21) Appl. No.: 15/106,466

(22) PCT Filed: Dec. 19, 2013
(86) PCT No.: PCT/KR2013/011845

§ 371 Date: Jun. 20, 2016

(51) Int. Cl. B65D 75/58; B29C 45/14; B65D 41/04

(52) U.S. Cl. CPC B65D 75/5883; B65D 41/04; B29C 45/14598; B29K 2025/06

(57) ABSTRACT

The present invention relates to a pouch container including a pouch main body to be filled with liquid contents; an inner tube which includes an inserted portion to be inserted in the pouch main body, an inlet portion for putting or withdrawing the liquid contents in or out, and a connecting portion of connecting the inserted portion and the inlet portion, and provides a tubular passage for the liquid contents; and an outer tube which is softer than the inner tube, and surrounds at least one of the connecting portion and the inlet portion. Thus, it is possible to solve problems of inconvenience and prevents damage to a consumer when s/he drinks liquid contents since the inlet portion is partially made of a soft material.

### REFERENCE TO RELATED APPLICATIONS

This is a U.S. National Phase Application of International Patent Application PCT/KR2013/011845 filed on Dec. 19, 2013, which designates the United States, the entire contents of which are incorporated herein by reference.

### FIELD OF THE INVENTION

The present invention relates to a pouch container.

### BACKGROUND OF THE INVENTION

A pouch, in which slush ice-cream, jelly or the like liquid contents are packaged for sale, includes a pouch main body made of a synthetic resin film or a metal sheet, and an inlet shaped like a pipe made of plastic or the like hard material so that the liquid contents can be put in or withdrawn from the pouch.

A consumer drinks the contents in the pouch through the hard inlet, and thus his/her lips or oral cavity may be damaged by the hard inlet.

In particular, the inlet has many sharp flanges needed for manufacturing processes of putting the contents in the pouch. Further, children are likely to put the inlet of the pouch into their mouths up to the flanges while drinking the contents, and their lips or oral cavities are easily damaged.

### SUMMARY OF THE INVENTION

Accordingly, an object of the present invention is to provide a pouch container which solves problems of inconvenience and prevents damage to a consumer when she/he drinks liquid contents filled in the pouch container.

The foregoing aspects are achieved by providing a pouch container including a pouch main body to be filled with liquid contents; an inner tube which includes an inserted portion to be inserted in the pouch main body, an inlet portion for putting or withdrawing the liquid contents in or out, and a connecting portion of connecting the inserted portion and the inlet portion, and provides a tubular passage for the liquid contents; and an outer tube made of a material softer than that of the inner tube, and surrounding at least one of the connecting portion and the inlet portion.

The outer tube may be formed as a single body to surround both the connecting portion and the inlet portion.

The connecting portion may comprise at least one flange protruding outward in a radial direction, and the outer tube may be formed to surround the at least one flange, thereby preventing damage to a consumer.

The inlet portion of the inner tube may comprise a screw thread for holding the cap, and the outer tube may be formed to surround the screw thread of the inlet portion.

Another aspect may be achieved by providing a pouch container including a pouch main body to be filled with liquid contents; a first tube which comprises an inserted portion to be inserted in the pouch main body, and a flange portion formed integrally with the inserted portion and having at least one flange portion protruding outward in a radial direction; and a second tube which is connected to an end of the flange portion, forms an inlet for putting or withdrawing the liquid contents in or out, and made of a material softer than that of the first tube.

Still another aspect may be achieved by providing a method of manufacturing a pouch container, the method including: forming an inner tube which includes an inserted portion to be inserted in the pouch main body, an inlet portion for putting or withdrawing the liquid contents in or out, and a connecting portion of connecting the inserted portion and the inlet portion, and provides a tubular passage for the liquid contents; and forming an outer tube made of a material softer than that of the inner tube, and surrounding at least one between the connecting portion and the inlet portion of the inner tube.

The forming the inner tube and the forming the outer tube may comprise injection-molding, and the forming the outer tube may comprise coating.

With this configuration, it is possible to solve problems of inconvenience and prevents damage to a consumer when she/he drinks liquid contents since the inlet portion is partially made of a soft material.

### BRIEF DESCRIPTION OF THE DRAWINGS

FIG. 1 is a perspective view of a pouch container according to an embodiment of the present invention,

FIG. 2 is a cross-section view taken along line II-II of FIG. 1 according to a first embodiment,

FIG. 3 is a cross-section view taken along line II-II of FIG. 1 according to a second embodiment,

FIG. 4 is a cross-section view taken along line II-II of FIG. 1 according to a third embodiment,

FIG. 5 is a cross-section view taken along line II-II of FIG. 1 according to a fourth embodiment, and

FIG. 6 is a flowchart of manufacturing the pouch container.

### DETAILED DESCRIPTION OF THE INVENTION

Below, embodiments of the present invention will be described in detail with reference to accompanying drawings.

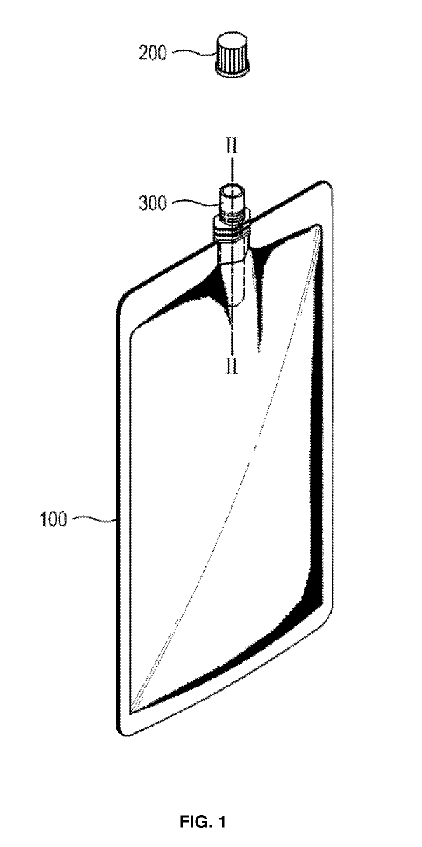

As shown in FIG. 1, the pouch container according to a first embodiment of the present invention includes a pouch main body 100, an inlet 300 partially inserted in the pouch main body 100, and a cap 200 opening and closing the inlet 300.

The pouch main body 100, to be filled with liquid contents such as slush ice-cream or jelly, is generally made of a synthetic resin film, a metallic sheet or a plurality of layered sheets. The edges of the pouch main body 100 except a middle portion are sealed up by adhesion, fusion or the like method so as to prevent the liquid contents from leaking out. The unsealed middle portion receives the inlet 300 and then the inlet 300 is adhered and sealed with.

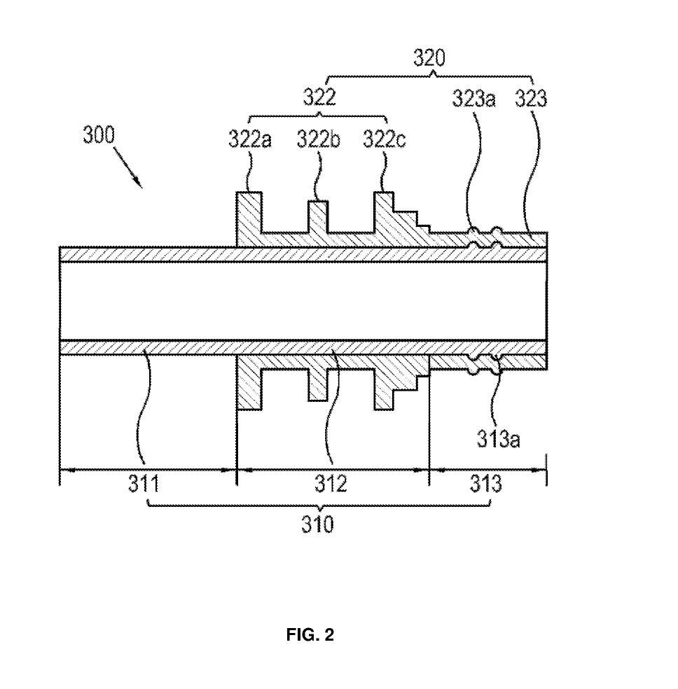

As shown in FIG. 2, the inlet 300 includes an inner tube 310 employed as a tubular passage for the liquid contents, and an outer tube 320 surrounding the inner tube 310.

The inner tube 310 partially inserted in the pouch main body 100 is formed as a single body, but will be described for convenience as it includes an inserted portion 311, an inlet portion 313 and a connecting portion 312.

The inlet portion 313, the inserted portion 311 and the connecting portion 312 may be integrally injection-molded like a single tube, but not limited thereto. Alternatively, they may be formed with different materials, respectively. Here, the inner tube 310 is made of plastic, PET or the like harmless material.

The inserted portion is inserted in the pouch main body 100. The inserted portion 311 is made of a relatively hard material in order to keep its tubular shape while preventing the passage from being clogged by a press or the like external force and making the liquid contents stored in the pouch main body 100 be easily put in and withdrawn out.

The inlet portion 313 through which the liquid contents can be put in or withdrawn out, is placed in an outward end section of the inner tube 310 and formed with an inner tube screw thread 313a. The inner tube screw thread 313a protrudes outward in a radial direction so as to strongly support the outer tube 320 provided at an outer side. Of course, the inner tube screw thread 313a may be omitted. Preferably, the end of the inlet portion 313 may be not angled but rounded to be in contact with an oral cavity or lips.

The connecting portion 312 connects the inserted portion 311 and the inlet portion 313 and is shaped like a pipe to pass the liquid contents. In the connecting portion 312, a flange portion 322 of the outer tube (to be described later) is arranged.

The outer tube 320 is arranged outside the inner tube 310 in an outward radial direction and made of a material softer than that of the inner tube 310. The outer tube 320 may include the flange portion 322, and an outer tube inlet portion 323.

The flange portion 322 includes a plurality of flanges 322a, 322b and 322c extended outward in the radial direction while surrounding the connecting portion 312 of the inner tube 310. The plurality of flanges 322a, 322b and 322c is formed to support the pouch main body 100 while the liquid contents are put in the pouch main body 100 or while a plurality of pouch main bodies 100 are carried at a time.

The outer tube inlet portion 323 is connected to the flange portion 322, and arranged corresponding to the inlet portion 313 of the inner tube 310. The outer tube inlet portion 323 includes an outer tube screw thread 323a corresponding to the inner tube screw thread 313a. The outer tube screw thread 323a is provided in the form of a male screw thread to hold the cap 200, and the cap 200 has a female screw thread corresponding to the outer tube screw thread 323a.

The outer tube 320 including the flange portion 322 and the outer tube inlet portion 323 is made of a material softer than that of the inner tube 310, thereby minimizing inconvenience or damage when a consumer puts the outer tube 320 to his/her lips to drink the liquid contents.

The outer tube 320 is made of a harmless material since it directly contacts a consumer's lips. The inner tube 310 is made of one between polyvinyl chloride (PVC) and polystyrene (PS), i.e. plastic which is relatively hard and harmless to humans. Likewise, the outer tube 320 is made of one between polyethylene terephthalate (PET) and polyethylene (PE), i.e. plastic which is softer than the inner tube 310 and harmless to humans.

The outer tube 320 may be formed to surround the inner tube 310 by applying secondary injection-molding to the primarily injection-molded inner tube 310. Alternatively, the flange portion 322 and the outer tube inlet portion 323 may be made of different soft materials, respectively. In addition, the flange portion and the outer tube inlet portion may be separately manufactured.

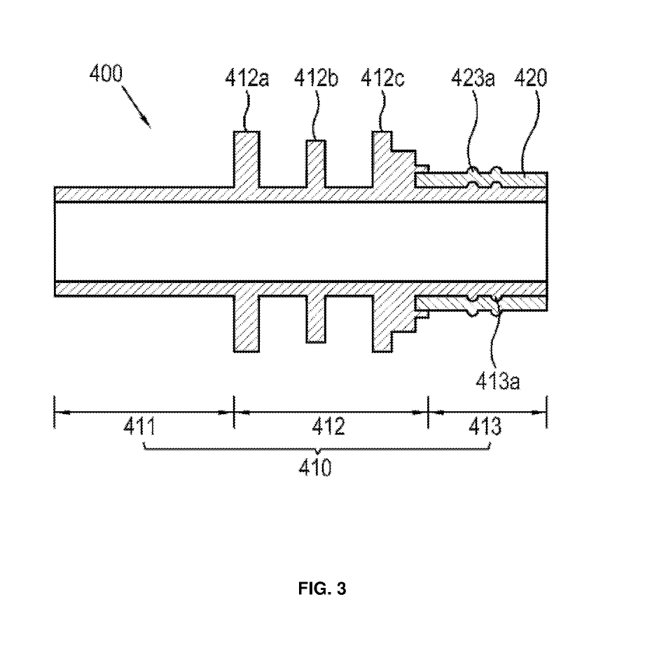

FIG. 3 illustrates an inlet 400 of a pouch container according to a second embodiment of the present invention.

The inlet 400 includes an inner tube 410 employed as a tubular passage for liquid contents, and an outer tube 420 surrounding the inner tube 410.

The inner tube 410 is made of a relatively hard material in order to prevent the passage from being deformed so that the liquid contents can be easily put in and withdrawn out.

The inner tube 410 is formed as a single body, but will be described for convenience as it includes an inserted portion 411, an inlet portion 413 and a connecting portion 412.

An end of the inserted portion 411 is inserted in the pouch main body 100 and adhered together with the pouch main body 100.

The connecting portion 412 is formed with a plurality of flanges 412a, 412b and 412c protruding outward in a radial direction and used in a process of putting the liquid contents in the pouch. The flanges 412a, 412b and 412c are made with the same material as the connecting portion 412, and the flanges 412a, 412b and 412c and the connecting portion 412 are formed as a single body. Since the flanges 412a, 412b and 412c are made of a relatively hard material, they can serve to support the pouch in a rail in the process of putting the liquid contents in the pouch.

The inlet portion 413 through which the liquid contents are put in or withdrawn out, is connected to the connecting portion 412, and includes an inlet for putting or withdrawing the contents in or out. The inlet portion 413 may include an inner tube screw thread 413a. The inner tube screw thread 413a serves to strongly support the outer tube 420 (to be described later).

As shown in FIG. 3, the outer tube 420 is arranged at a position corresponding to the inlet portion 413 of the inner tube 410. The outer tube 420 is made of a material softer than that of the inlet portion 413.

Therefore, the outer tube 420 made of a soft material is arranged at a position corresponding to the inlet portion 413 to be in contact with a consumer's lips, and prevents a consumer's mouth or lips from being damaged.

The outer tube 420 includes an outer tube screw thread 423a protruding in the radial direction corresponding to the inner tube screw thread 413a. The outer tube screw thread 423a is provided in the form of the male screw thread, so that the cap 200 having a female screw thread can be mounted to the outer tube 420.

The outer tube 420 may be formed by applying secondary injection-molding to the primarily injection-molded and hard inner tube 410. Alternatively, the outer tube 420 may be manufactured by a coating process.

Since the inner tube 410 and the outer tube 420 are in contact with a consumer's oral cavity or lips, they have to be made of a material harmless to humans. The inner tube 410 is made of one between polyvinyl chloride (PVC) and polystyrene (PS), i.e. plastic which is relatively hard and harmless to humans. Likewise, the outer tube 420 is made of one between polyethylene terephthalate (PET) and polyethylene (PE), i.e. plastic which is softer than the inner tube 410 and harmless to humans.

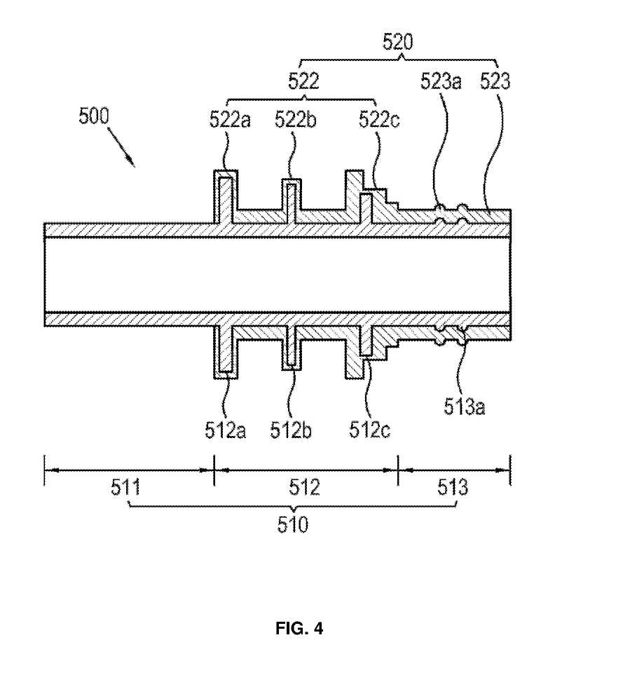

FIG. 4 illustrates an inlet 500 of a pouch container according to a third embodiment of the present invention.

The inlet 500 includes an inner tube 510 employed as a tubular passage for liquid contents, and an outer tube 520 surrounding the inner tube 510.

The inner tube 510 is made of a relatively hard material in order to prevent the passage from being deformed so that the liquid contents can be easily put in and withdrawn out. Here, the inner tube is made of polyvinyl chloride (PVC) or polystyrene (PS), which is relatively hard and harmless to humans.

The inner tube 510 is formed as a single body, but will be described for convenience as it includes an inserted portion 511, an inlet portion 513 and a connecting portion 512 connecting the inserted portion 511 and the inlet portion 513.

The inserted portion 511 is inserted in the pouch main body 100 and shaped like a pipe through which the liquid contents can be put in or withdrawn out.

The inlet portion 513 is connected to the connecting portion 512 of the inlet 510, and includes an inlet for putting or withdrawing the contents in or out. The inlet portion 513 may include an inner tube screw thread 513a. The inner tube screw thread 513a protrudes outward in a radial direction and serves to strongly support the outer tube 520 (to be described later).

As shown in FIG. 4, the connecting portion 512 is formed integrally with a plurality of inner tube flanges 512a, 512b and 512c protruding outward in a radial direction.

The outer tube 520 is formed integrally with an outer tube inlet portion 523 having an outer tube screw thread 523a corresponding to the inner tube screw thread 513a, and a flange portion 522 having outer tube flanges 522a, 522b and 522c surrounding the inner tube flanges 512a, 512b and 512c, in which they are made of one material. The outer tube 520 is formed as a single body in practice, but will be described for convenience as it includes the outer tube inlet portion 523 and the flange portion 522.

The outer tube 520 is made of a material softer than the inner tube 510 so as to prevent a consumer from being damaged while drinking the liquid contents. The inner tube flanges 512a, 512b and 512c are surrounded with the outer tube 520 for protecting a consumer's lips, but the inner tube flanges 512a, 512b and 512c themselves are made of a hard material. Therefore, it is possible to support the pouch in a rail in the process of putting the liquid contents in the pouch.

As necessary, only the inner tube flange 512a, closer to the inlet portion 513 to be in contact with a consumer's lips, among the plurality of inner tube flanges 512a, 512b and 512c may be surrounded with the outer tube 520. Alternatively, only the inner tube flanges 512a, 512b and 512c except the inlet portion 513 may be surrounded with the outer tube 520. The outer tube 520 may be formed by injection-molding or may be coated using a soft material.

The outer tube may be made of one between polyethylene terephthalate (PET) and polyethylene (PE), which is softer than the inner tube and harmless to humans.

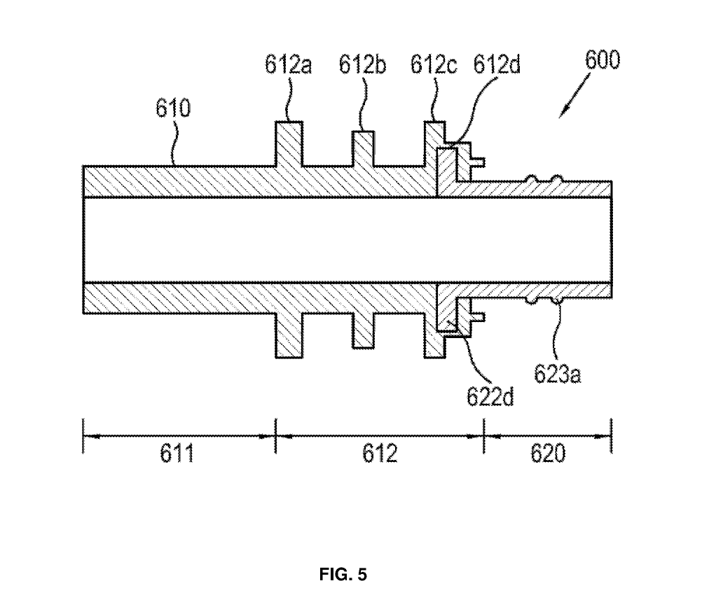

FIG. 5 illustrates an inlet 600 of a pouch container according to a fourth embodiment of the present invention.

The inlet 600 includes a first tube 610, and a second tube 620 coupling with the first tube 610 and softer than a material of the first tube 610.

Since the first tube 610 and the second tube 620 are in contact with a consumer's oral cavity or lips, they have to be made of a material harmless to humans. The first tube 410 is made of a material to prevent the passage from being deformed so that the liquid contents can be put in or withdrawn out, and therefore made of one between polyvinyl chloride (PVC) and polystyrene (PS), i.e. plastic which is relatively hard and harmless to humans. Likewise, the outer tube 420 is made of one between polyethylene terephthalate (PET) and polyethylene (PE), i.e. plastic which is softer than a material of the inner tube 410 and harmless to humans so that a consumer's oral cavity or lips can be prevented from being damaged.

The first tube 610 includes an inserted portion 611 inserted in the pouch main body 100, and a flange portion 612 formed integrally with the inserted portion 611 and having a plurality of flanges 612a, 612b and 612c protruding outward in a radial direction. The first tube 610 is formed as a single body, but will be described for convenience as it includes the inserted portion 611 and the flange portion 612.

The flange portion 612 is formed with a coupling groove 612d at an end thereof, and couples with the second tube 620 having a coupling projection 622d. The second tube 620 is an outlet for the liquid contents, which is in contact with a consumer's mouth and lips so that she/he can drink the liquid contents, and includes a screw thread 623a for coupling with the cap 200.

The second tube 620 is softer than a material of the first tube 610 and thus prevents a consumer from being damaged when she/he drinks the contents. In addition, the second tube 620 may be not angled but rounded to reduce a consumer's damage.

As a method of coupling the first tube 610 and the second tube 620, the first tube 610 and the second tube 620 are respectively formed by injection-molding or the like, and the soft second tube 620 is then forcibly fitted to the first tube 610 so that the coupling groove 612b of the first tube 610 can be couple with the coupling projection 620b of the second tube 620.

Besides, the second tube 620 may be primarily formed and then the first tube 610 may be secondarily formed in consideration of the coupling projection 620b.

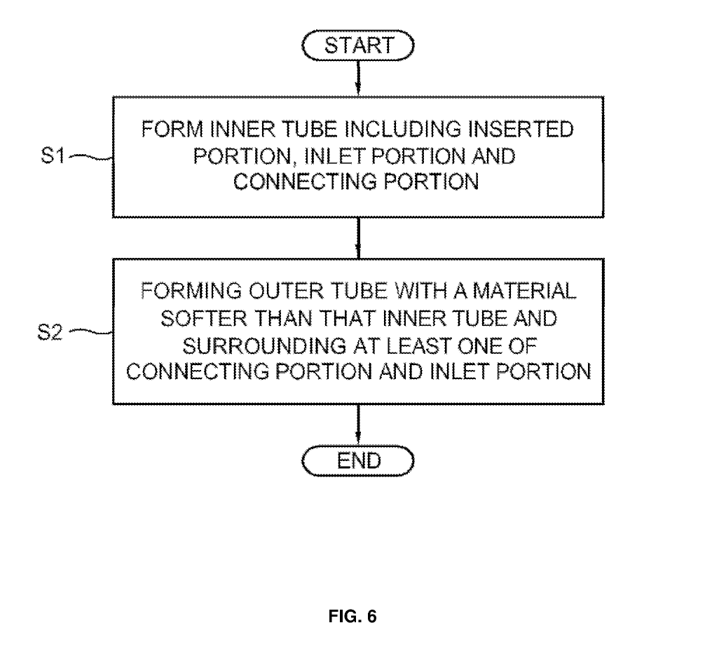

As shown in FIG. 6, a method of manufacturing the inlet 300, 400, 500, 600 of the pouch container according to the present invention includes first forming the inner tube 310 (S1), and then forming the outer tube surrounding at least one of the connecting portion and the inlet portion.

The methods of manufacturing the inlets according to the first to fourth embodiment described with reference to FIGS. 2 to 5 are as follows.

In case of the inlet 300 according to the first embodiment, the inner tube 310 is formed to include the inserted portion 311 to be inserted in the pouch main body 100, the inlet portion 313 for putting or withdrawing the liquid contents in or out, and the connecting portion 312 for connection between the inserted portion 311 and the inlet portion 313 (S2). The inner tube 310 is formed to provide a tubular passage to pass the liquid contents.

The outer tube 320 is formed to surround the inner tube 310 (S2). The outer tube 320 including the flange portion 322 and the outer tube inlet portion 323 is softer than a material of the inner tube 310 and thus prevents a consumer from getting a cut on his/her lips from the hard inner tube 310 when she/he drinks the liquid contents filled in the pouch main body 100.

In case of the inlet 400 according to the second embodiment, the inner tube is first formed (S1). The inner tube 410, which includes the inserted portion 411, the inlet portion 413, and the connecting portion 412 for connection between the inserted portion 411 and the inlet portion 413, is formed to provide a tubular passage to pass the liquid contents. The inserted portion 411, the inlet portion 413 and the connecting portion 412 are formed as a single body by injection-molding. The inserted portion includes the flanges 412a, 412b and 412c extended outward in a radial direction, and made of the same material as the inserted portion.

Then, the outer tube 420 is formed to surround the inlet portion 413 (S2). On the contrary to the first embodiment, the flanges 412a, 412b and 412c are extended from the inner tube 410, thereby surrounding not the connecting portion 412 but only the inlet portion 413. The outer tube 420 is made of a material softer than that of the inner tube 410. Alternatively, the outer tube 420 may be formed by not injection-molding but coating using a soft material.

In the inlet 500 according to the third embodiment, the inner tube 510 is first formed (S1). The inner tube 510, which includes the inserted portion 511, the inlet portion 513 and the connecting portion 512, is formed to provide a tubular passage to pass the liquid contents. The inserted portion 511, the inlet portion 513 and the connecting portion 512 are formed as a single body by injection-molding. The connecting portion 512 is provided with the inner tube flanges 512a, 512b and 512c made of the same material as the connecting portion 512 and protruding outward in a radial direction.

Then, the outer tube 520 is formed to surround the inner tube flanges 512a, 512b, 512c and the inlet portion 513 (S2). A consumer may be damaged by the relatively hard inner tube flanges 512a, 512b and 512c if she/he drinks the contents by putting his/her mouth or lips to not only the inlet portion but also the inner tube flanges 512a, 512b and 512c. To prevent this, the outer tube flanges 522a, 522b and 522c are formed to surround the inner tube flanges 512a, 512b and 512c.

The outer tube 520 is made of a material softer than that of the inner tube 510, and manufactured by injection-molding to surround the inlet portion 513 and the inner tube flanges 512a, 512b and 512c. Alternatively, the outer tube 520 may be manufactured by not the injection-molding but coating using a soft material.

In case of the inlet 600 according to the fourth embodiment, the first tube 610 is first formed. The first tube 610 includes the inserted portion 611, and the flange portion 612 having the plurality of flanges 612a, 612b and 612c protruding outward in a radial direction and the coupling groove 612d at the end thereof. The first tube 610 is formed as a single body with a relatively hard material.

The second tube 620 is formed to have the coupling projection 622d. The second tube 620 is formed by injection-molding with a material softer than that of the first tube 610. After forming the first tube 610 and the second tube 620, the coupling groove 612d of the first tube 610 couples with the coupling projection 622d of the second tube 620 by forcible fitting or the like.

What is claimed is:

1. A pouch container comprising a pouch main body to be filled with liquid contents, and an inlet,
the inlet comprising:
an inner tube which includes an inserted portion to be inserted in the pouch main body, an inlet portion for putting or withdrawing the liquid contents in or out, and a connecting portion of connecting the inserted portion and the inlet portion, and provides a tubular passage for the liquid contents; and
an outer tube made of a material softer than that of the inner tube, and surrounding at least one of the connecting portion and the inlet portion.

2. The pouch container according to claim 1, wherein the outer tube is formed as a single body to surround both the connecting portion and the inlet portion.

3. The pouch container according to claim 1, wherein the connecting portion comprises at least one flange protruding outward in a radial direction.

4. The pouch container according to claim 3, wherein the outer tube is formed to surround the at least one flange.

5. The pouch container according to claim 1, wherein the inlet portion of the inner tube comprises a screw thread for holding a cap, and
the outer tube is formed to surround the screw thread of the inlet portion.

6. A pouch container comprising a pouch main body to be filled with liquid contents, and an inlet,
the inlet comprising:
a first tube which comprises an inserted portion to be inserted in the pouch main body, and a flange portion formed integrally with the inserted portion and having at least one flange protruding outward in a radial direction; and
a second tube which is connected to an end of the flange portion, forms an inlet portion for putting or withdrawing the liquid contents in or out, and made of a material softer than that of the first tube.

7. A method of manufacturing a pouch container, the method comprising:
forming an inner tube which includes an inserted portion to be inserted in the pouch main body, an inlet portion for putting or withdrawing the liquid contents in or out, and a connecting portion of connecting the inserted portion and the inlet portion, and provides a tubular passage for the liquid contents; and
forming an outer tube made of a material softer than that of the inner tube, and surrounding at least one between the connecting portion and the inlet portion of the inner tube.

8. The method according to claim 7, wherein the forming the inner tube and the forming the outer tube comprise injection-molding.

9. The method according to claim 7, wherein the forming the outer tube comprises coating.
